(19) United States
(12) Patent Application Publication
(10) Pub. No.: US 2016/0175839 A1
(43) Pub. Date: Jun. 23, 2016

(54) DIGITAL MICROFLUIDIC DEVICES AND METHODS OF DISPENSING AND SPLITTING DROPLETS IN DIGITAL MICROFLUIDIC DEVICES

(71) Applicant: BOARD OF REGENTS, THE UNIVERSITY OF TEXAS SYSTEM, Austin, TX (US)

(72) Inventors: Hyejin MOON, Euless, TX (US); Jagath NIKAPITIYA, Scarborough (CA)

(21) Appl. No.: 14/976,019

(22) Filed: Dec. 21, 2015

Related U.S. Application Data
(60) Provisional application No. 62/094,744, filed on Dec. 19, 2014.

(51) Int. Cl. B01L 3/00

(52) U.S. Cl. CPC B01L 3/50273; B01L 2200/0605; B01L 2400/0427; B01L 2300/06

(57) ABSTRACT

In one aspect, digital microfluidic devices are described herein. In some embodiments, a device described herein comprises a droplet-dispensing component, the droplet-dispensing component comprising a first linear electrode segment, a second linear electrode segment, and a curved electrode segment connecting the first linear electrode segment and the second linear electrode segment. The curved electrode segment subtends an angle of about 90 degrees. Thus, in some embodiments, the droplet-dispensing component formed by the first linear electrode segment, the second linear electrode segment, and the curved electrode segment can be L-shaped or define an L-junction. Further, in some instances, the first and/or second linear electrode segment is formed from a plurality of contiguous electrodes. Additionally, the contiguous electrodes may be rectangular. The curved electrode segment of the droplet-dispensing component may also be formed from a plurality of electrodes, such as angled or sector-shaped electrodes.

### CROSS REFERENCE TO RELATED APPLICATIONS

This application claims priority pursuant to 35 U.S.C. §119(e) to U.S. Provisional Patent Application Ser. No. 62/094,744, filed on Dec. 19, 2014, which is hereby incorporated by reference in its entirety.

### STATEMENT REGARDING FEDERALLY SPONSORED RESEARCH

This invention was made with government support under contract W31P4Q-11-1-0012 awarded by the Defense Advanced Research Projects Agency/Microsystems Technology Office (DARPA/MTO). The government has certain rights in the invention.

### FIELD

This invention relates to digital microfluidic (DMF) devices and, in particular, to methods of dispensing and splitting droplets in DMF devices having a parallel plate structure.

### BACKGROUND

In an electrowetting-on-dielectric (EWOD) DMF device, the formation and motion of individual droplets can be controlled by applying an external electric field to designated electrodes within the device. Intricate pump and/or valve systems are thus not needed in such devices to drive and regulate the flow of liquids. In addition, droplets can be individually created and controlled in an EWOD DMF device, thus permitting the multiplexing of many droplets on a two-dimensional surface. Due to these advantages, EWOD DMF devices have been used in a variety of applications. For some applications, droplet volume precision, droplet volume consistency, droplet dispensing or splitting frequency, and/or droplet motion speed can be important.

Unfortunately, many existing DMF devices suffer from low droplet volume precision, poor droplet volume consistency, and/or slow droplet dispensing or splitting speeds. Some existing DMF devices also include complicated components for controlling droplet formation and/or movement, leading to an increase in fabrication cost and/or the number of failure modes. Therefore, there exists a need for improved DMF devices and methods of dispensing and splitting droplets in such devices.

### SUMMARY

In one aspect, DMF devices are described herein which, in some embodiments, can provide one or more advantages compared to some prior devices. For example, in some embodiments, a device described herein can dispense individual nanodroplets with a high precision and/or high consistency in droplet volume. Volume precision can be defined as the difference between dispensed volume and volume subtended by the drop-dispensing electrode of a device, where smaller differences correspond to higher volume precision. Volume consistency can be defined as the standard deviation of the volumes of a population of dispensed droplets. In some cases, a device described herein can provide a volume precision and/or a volume consistency of ±5% or less. A device described herein, in some cases, can also dispense and/or split droplets rapidly. For instance, in some embodiments, a device described herein can dispense and/or split a droplet in less than 15 ms. Moreover, a device described herein can provide one or more of the foregoing advantages without the need to use additional device components or additional process steps, such as those used in some prior capacitive feedback devices. Additionally, in some embodiments, a device described herein can be used to couple droplets having precise and consistent volumes to an additional apparatus, such as a polymerase chain reaction (PCR) apparatus. Thus, devices described herein, in some instances, can be used for various drug delivery, bioassay, in vitro, ecology, and/or pharmaceutical applications.

A DMF device described herein, in some embodiments, comprises an EWOD device. Further, DMF devices described herein can be “closed,” “parallel plate,” or “two-sided” devices, as opposed to “open” or “single-sided” devices. Thus, in some cases, a DMF device described herein can comprise a first parallel plate, a second parallel plate in facing opposition to the first parallel plate, and a gap between the first and second parallel plates. Fluid droplets can be formed and/or manipulated in the gap while in contact with the first and/or second parallel plate. Moreover, the first and/or second parallel plate can comprise a substrate, electrical contacts or electrodes positioned on or over the substrate, a dielectric layer positioned over the electrodes and substrate, and, in some cases, a hydrophobic coating positioned on the dielectric layer. A droplet disposed between the plates can be in contact with the topmost layer, such as the dielectric layer or hydrophobic coating, of each plate. Further, the spatial position of the electrodes in a parallel plate EWOD device described herein can define, form, or determine functional components of the device. For example, the placement of electrodes in a parallel plate device can form droplet-dispensing components, droplet-splitting components, bioassay components, reaction components, and other components, as described further herein.

In some embodiments, a DMF device described herein comprises a droplet-dispensing component. In some cases, the droplet-dispensing component comprises a droplet-generating electrode and a T-shaped electrode adjacent to the droplet-generating electrode. Additionally, in some embodiments, such a droplet-dispensing component further comprises an additional electrode adjacent to the T-shaped electrode. As described further hereinbelow, this additional electrode can contact or be immediately adjacent to the T-shaped electrode on three sides, four sides, or five sides of the T-shape of the T-shaped electrode. For example, in some instances, the additional electrode is a first C-shaped electrode adjacent to the T-shaped electrode. Further, in some cases, the droplet-dispensing component of a device described herein also comprises a second additional electrode, such as a second C-shaped electrode, adjacent to the first additional electrode. The T-shaped electrode, the first additional electrode, and the second additional electrode can be immediately adjacent to one another, including in embodiments wherein the first additional electrode is a first C-shaped electrode and the second additional electrode is a second C-shaped electrode. Moreover, in some such instances, the second C-shaped electrode is larger than the first C-shaped electrode, and the first C-shaped electrode and the second C-shaped electrode are nested. Further, the droplet-generating electrode, the T-shaped electrode, the first additional (e.g., C-shaped) electrode, and the second additional (e.g., C-shaped) electrode may be symmetric about a common axis, such as an axis corresponding to the direction of movement of a droplet dispensed by the droplet-dispensing component. Additionally, in some cases, about one-third to two-thirds of the droplet-generating electrode overlaps with the T-shape of the T-shaped electrode. Further, in some embodiments, the droplet-generating electrode of a device described herein has a rounded shape, such as a circular shape or a tear-drop shape.

In other cases, a droplet-dispensing component of a device described herein comprises a first linear electrode segment, a second linear electrode segment, and a curved electrode segment connecting the first linear electrode segment and the second linear electrode segment, wherein the curved electrode segment subtends an angle of about 90 degrees. Thus, in some embodiments, the droplet-dispensing component formed by the first linear electrode segment, the second linear electrode segment, and the curved electrode segment can be L-shaped or define an L-junction. Further, in some instances, the first and/or second linear electrode segment is formed from a plurality of contiguous electrodes. Additionally, the contiguous electrodes may be rectangular. The curved electrode segment of the droplet-dispensing component may also be formed from a plurality of electrodes, such as angled or sector-shaped electrodes.

Digital microfluidic devices described herein, in some embodiments, can also comprise a droplet-splitting component. The droplet-splitting component, in some cases, comprises a first linear electrode segment, a second linear electrode segment, a third linear electrode segment, and a Y-junction electrode segment connecting the first linear electrode segment to the second and third linear electrode segments. Further, in some embodiments, the first linear electrode segment, the second linear electrode segment, the third linear electrode segment, and the Y-junction electrode segment can form a Y-shape and/or define an acute angle. Additionally, in some instances, the Y-shape and the first linear electrode segment are symmetric about a common axis. Such an axis may correspond to a direction of movement of a droplet split by the droplet-splitting component. Moreover, in some embodiments, the first, second, and/or third linear electrode segment is formed from a plurality of contiguous electrodes. Additionally, the contiguous electrodes of the first, second, and/or third linear electrode segment may be rectangular. Further, in some cases, the second and third linear electrode segments form the arms of the Y-shape. In addition, in some embodiments, the Y-junction electrode segment of the droplet-splitting component is formed from a plurality of contiguous electrodes, which may be angled electrodes. In some such instances, the angles formed by the angled electrodes decrease from the first linear segment toward the second and third linear segments.

In another aspect, methods of dispensing and/or splitting a droplet in a DMF device are described herein. Methods described herein, in some instances, can be carried out using a DMF device described hereinabove, including a parallel plate DMF device.

A method of dispensing a droplet described herein, in some embodiments, comprises dispensing the droplet from a reservoir fluid in a DMF device. Such a method can comprise covering a droplet-generating electrode of the device with a portion or “finger” of the reservoir fluid, the portion having a larger area than the droplet-generating electrode. Additionally, the method further comprises withdrawing the portion of the reservoir from the droplet-generating electrode while the droplet-generating electrode is in an on state to form a droplet on the droplet-generating electrode. The area of the droplet formed in this manner can be substantially the same as the area of the droplet-generating electrode. Moreover, in some cases, the droplet-generating electrode has a rounded shape, such as a circular, elliptical, or “rounded square” shape. Further, in some embodiments, the droplet-generating electrode is symmetric about an axis corresponding to the direction of droplet dispensing. Dispensing a droplet in this manner can improve the precision and consistency of droplet volumes.

In other cases, a method of dispensing a droplet from a reservoir fluid of a DMF device comprises providing a droplet-generating electrode having a rounded shape, such as a circular shape, and switching the droplet-generating electrode to an on state to form the droplet on the droplet-generating electrode. Moreover, in some embodiments, the area of the droplet is substantially the same as the area of the droplet-generating electrode. It is further to be understood that the droplet-generating electrode can be adjacent to the reservoir fluid. Further, in some instances, forming the droplet on the droplet-containing electrode comprises covering the droplet-generating electrode with a portion of the reservoir fluid having a larger area than the droplet-generating electrode. In addition, in some such embodiments, forming the droplet on the droplet-containing electrode further comprises withdrawing the portion of the reservoir fluid from the droplet-generating electrode while the droplet-generating electrode is in the on state. Dispensing a droplet in this manner can further improve the precision and consistency of dispensed droplet volumes, including by reducing or eliminating the unwetted area of the drop-generating electrode during drop formation.

Additionally, in still other embodiments, a method of dispensing a droplet from a reservoir fluid described herein comprises removing a portion of the reservoir fluid to form a droplet and a tail extending between the droplet and the reservoir fluid. Such a method further comprises forming at least one fixed meniscus of the reservoir fluid adjacent to the tail and also forming a fixed meniscus of the droplet adjacent to the tail. In some instances, the fixed meniscus of the reservoir fluid is substantially parallel to the fixed meniscus of the droplet. Alternatively, in other embodiments, the fixed meniscus of the reservoir fluid is substantially orthogonal to the fixed meniscus of the droplet. Additionally, in some cases, the curvature of the reservoir fluid adjacent to the tail and the curvature of the droplet adjacent to the tail are each infinite. Moreover, in some instances, two fixed menisci of the reservoir fluid are formed adjacent to the tail, the two fixed menisci being substantially parallel to one another. In addition, in some embodiments, a method described herein further comprises splitting the tail to divide the droplet from the reservoir fluid. Dispensing a droplet in a manner described herein can completely eliminate or reduce the length of the tail portion of the droplet, thereby improving the volume precision and consistency of dispensed droplets.

Further, in yet other embodiments, a method of dispensing a droplet from a reservoir fluid described herein comprises withdrawing a portion of the reservoir fluid and forcing the portion to form or subtend an acute angle during de-wetting and movement of the portion over a curved electrode segment. In some cases, such a method further comprises “pinching off” or separating the portion from the remainder of the reservoir fluid, thereby forming the dispensed droplet. In some such embodiments, dispensing the droplet also comprises forming a tail extending between the droplet and the reservoir fluid, forming at least one fixed meniscus of the reservoir fluid adjacent to the tail, and forming a fixed meniscus of the droplet adjacent to the tail, wherein the fixed meniscus of the reservoir fluid is substantially orthogonal or perpendicular to the fixed meniscus of the droplet. Dispensing a droplet in a manner described herein can improve the speed of droplet dispensing and/or the volume precision and consistency of dispensed droplets.

Methods of dispensing a droplet described herein, in some embodiments, can also comprise coupling or providing the dispensed droplet to an external apparatus, including an apparatus that is not a DMF device. For example, in some cases, a droplet dispensed in a manner described herein can be coupled or provided to a PCR apparatus. Droplets dispensed in a manner described herein can also be combined with one another and/or with other materials, including to react with chemical species present in the droplets. Thus, in some cases, methods described herein can be used to improve the precision, consistency, and/or throughout of another process, such as a bioassay process.

In still another aspect, methods of splitting a droplet in a DMF device are described herein. Methods of splitting a droplet described herein, in some cases, can provide divided or split droplets having high volume precision and/or high volume consistency. Methods of splitting a droplet described herein can also provide split or divided droplets at a high speed, thus facilitating improved throughput.

A method of splitting a droplet described herein, in some embodiments, comprises providing a droplet-splitting component described hereinabove, such as a droplet-splitting component comprising a first linear electrode segment, a second linear electrode segment, a third linear electrode segment, and a Y-junction electrode segment connecting the first linear electrode segment to the second and third linear electrode segments, wherein the first linear electrode segment, the second linear electrode segment, the third linear electrode segment, and the Y-junction electrode segment form a Y-shape or define an acute angle. Such a method can further comprise moving the droplet from the first linear component to the Y-junction electrode segment to split the droplet into a first droplet portion and a second droplet portion. Additionally, in some cases, the first droplet portion is disposed on the second linear electrode segment and the second droplet portion is disposed on the third linear electrode segment of the droplet-splitting component. More generally, in some instances, a method of splitting a droplet described herein comprises forcing a leading meniscus of the droplet to split at a junction defining an acute angle.

These and other embodiments are described in more detail in the detailed description which follows.

### BRIEF DESCRIPTION OF THE FIGURES

FIG. 1A and FIG. 1B each illustrates a top plan view of a droplet-dispensing component of a prior art DMF device.

FIG. 2A illustrates a top plan view of a droplet-dispensing component of a device according to one embodiment described herein.

FIG. 2B, FIG. 2C, FIG. 2D, FIG. 2E, FIG. 2F, and FIG. 2G each illustrates a step of a method of dispensing a droplet using the droplet-dispensing component of FIG. 2A.

FIG. 3A and FIG. 3B each illustrates a top plan view of a step of dispensing a droplet using the droplet-dispensing component of FIG. 2A.

FIG. 4A and FIG. 4B each illustrates a top plan view of a step of dispensing a droplet using a droplet-dispensing component of a device according to one embodiment described herein.

FIG. 5 illustrates a top plan view of a droplet-dispensing component of a device according to one embodiment described herein.

FIG. 6A, FIG. 6B, FIG. 6C, and FIG. 6D each illustrates a top plan view of a step of dispensing a droplet using the droplet-dispensing component of FIG. 5.

FIG. 7 illustrates a top plan view of a droplet-splitting component of a device according to one embodiment described herein.

FIG. 8A and FIG. 8B each illustrates a top plan view of a step of splitting a droplet using the droplet-dispensing component of FIG. 7.

### DETAILED DESCRIPTION

Embodiments described herein can be understood more readily by reference to the following detailed description, examples, and figures. Elements, apparatus, and methods described herein, however, are not limited to the specific embodiments presented in the detailed description, examples, and figures. It should be recognized that these embodiments are merely illustrative of the principles of the present invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” should generally be considered to include the end points 5 and 10.

Moreover, when the term “about” is used in connection with an amount or quantity, it is to be understood that the amount can vary by 5% or less, 3% or less, or 1% or less, where the percentage is based on the stated amount. For example, an amount of “about 100” can refer to an amount of 95-105, 97-103, or 99-101.

### I. Digital Microfluidic Devices

In one aspect, DMF devices are described herein. In some embodiments, a DMF device described herein comprises a droplet-dispensing component. A droplet-dispensing component of a device described herein can provide one or more improvements compared to some prior DMF devices. For example, a droplet-dispensing component described herein can dispense individual nanodroplets with a high speed and/or a high precision and/or high consistency in droplet volume.

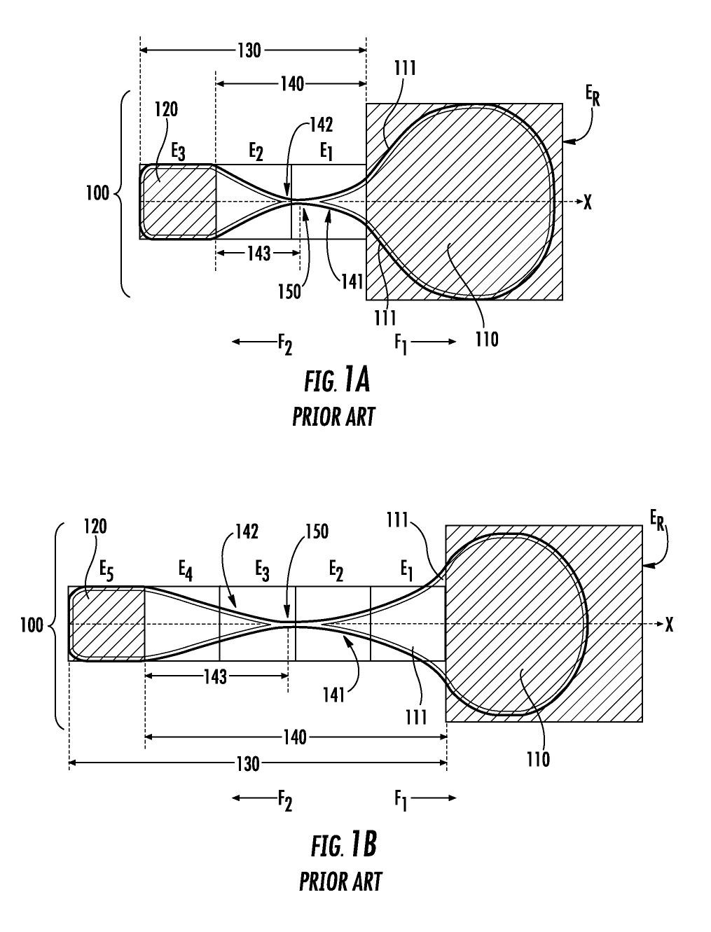

FIG. 1A illustrates a process of dispensing a droplet using a conventional DMF device. As illustrated in FIG. 1A, a prior art droplet-dispensing component (100) includes a fluid reservoir or reservoir drop (110) disposed on a square reservoir electrode (E_{R}). The square reservoir electrode (E_{R}) is contiguous with additional square electrodes (E₁, E₂, E₃). As illustrated in FIG. 1A, electrode E₃ is a droplet-generating electrode, where a “droplet-generating” electrode refers to an electrode on which a free droplet is formed or dispensed from the fluid reservoir (110). The droplet-dispensing component (100) is used to dispense a droplet (120) by extruding a liquid “finger” or portion of fluid (130) from the reservoir through activation of adjacent serial electrodes. “Activation” of an electrode, for reference purposes herein, refers to switching the electrode from an “off” state in which no voltage is applied to the electrode to an “on” state in which voltage is applied to the electrode. For example, one or more of the additional square electrodes (E₁, E₂, E₃) can be activated while the reservoir electrode (E_{R}) is in a deactivated or off state, thereby pulling a portion of fluid (130) from the reservoir (110). As illustrated in FIG. 1A, the portion of fluid (130) includes the droplet (120) and a tail (140). A “tail,” for reference purposes herein, comprises a portion of fluid defining two menisci extending between two fluid portions during a droplet-dispensing process, such as the menisci (141, 142) extending between the droplet (120) and the reservoir fluid (110) in FIG. 1A. Further, as used herein, the “tail” can refer to the entire portion of fluid extending between the two fluid portions, rather than referring to only half of the total portion, such as the half closest to the droplet being dispensed (labeled as 143 in FIG. 1A). Again with reference to FIG. 1A, to separate the droplet (120) from the fluid reservoir (110), the tail (140) must be split. To split the tail (140) to complete the dispensing of the droplet (120), opposite forces can be applied to the portion of fluid (130). For example, as illustrated in FIG. 1A, the tail (140) can be split by placing electrodes E_{R} and E₃ in an on state and placing electrodes E₁ and E₂ in an off state (for illustration purposes herein, an electrode in an on state is depicted in the figures with hatching, and an electrode in an off state is depicted without hatching or shading). As understood by one of ordinary skill in the art, an electrode in an on state in an EWOD device can attract a droplet and/or cause a droplet to de-wet an electrode in an off state. The electrode in the off state can be immediately adjacent the electrode in the on state or spaced apart from the electrode in the on state. Such a configuration in the device of FIG. 1A results in the formation of opposing forces (F₁, F₂) on the portion of fluid (130). The continued application of the forces (F₁, F₂) results in breaking or splitting of the tail (140) at a “pinch-off” or “pinching off” point (150).

FIG. 1B illustrates a similar droplet-dispensing component (100) and droplet-dispensing process as illustrated in FIG. 1A. However, in FIG. 1B, the fluid reservoir (110) has a smaller volume than the fluid reservoir (110) of FIG. 1A. In addition, the droplet-dispensing component (100) of FIG. 1B includes a larger number of additional electrodes (E₁, E₂, E₃, E₄, E₅) adjacent to the reservoir electrode (E_{R}). Further, in the device of FIG. 1B, electrode E₅ is the droplet-generating electrode. Moreover, the pinch-off points (150) in FIGS. 1A and 1B differ. In FIG. 1A, the pinch off point (150) is closer to the middle of the tail (140) than is the case in FIG. 1B. In the devices of FIGS. 1A and 1B, the location of the pinch-off point (150) can depend on various factors, including the volume of the fluid reservoir (110). Thus, the pinch-off point (150) is inconsistent in devices having a configuration such as that illustrated in FIGS. 1A and 1B. As a result, differing volumes of the tail (140) may be added to the droplet (120) when dispensing is complete in any given instance. Thus, control over the volume of the droplet (120) is limited, particularly for a series of droplets dispensed from the same fluid reservoir, resulting in poor droplet volume consistency. Not intending to be bound by theory, it is believed that the inconsistency may be due at least in part to inconsistent intercept of the front meniscus (111) of the fluid reservoir (110) with the boundary between the reservoir electrode (E_{R}) and the immediately adjacent electrode (E₁).

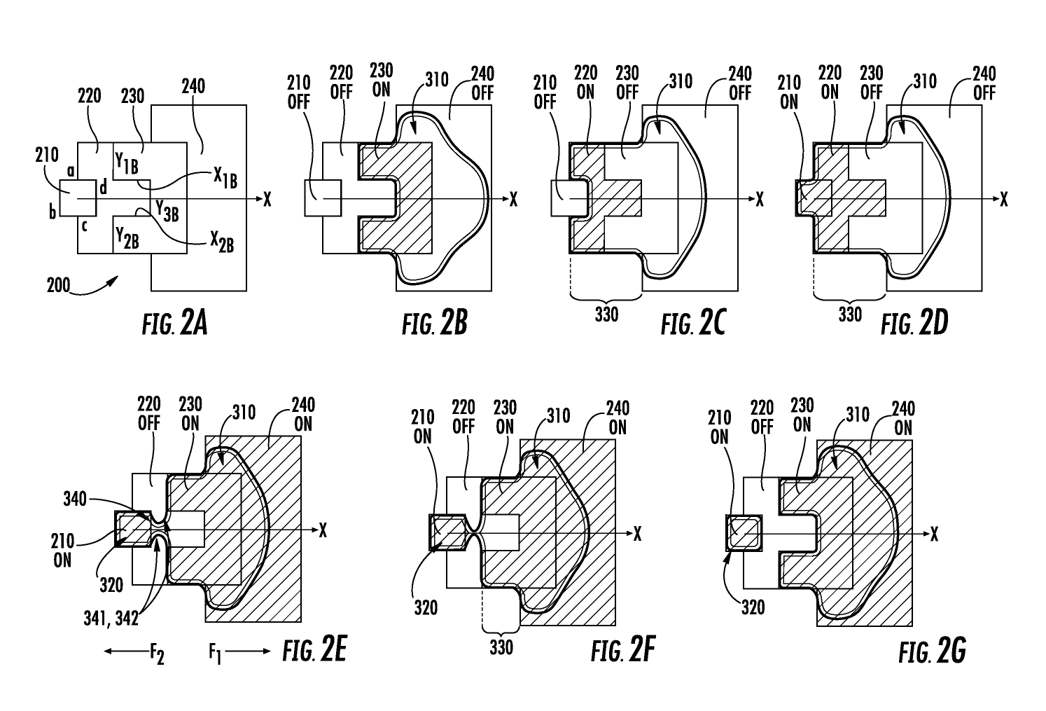

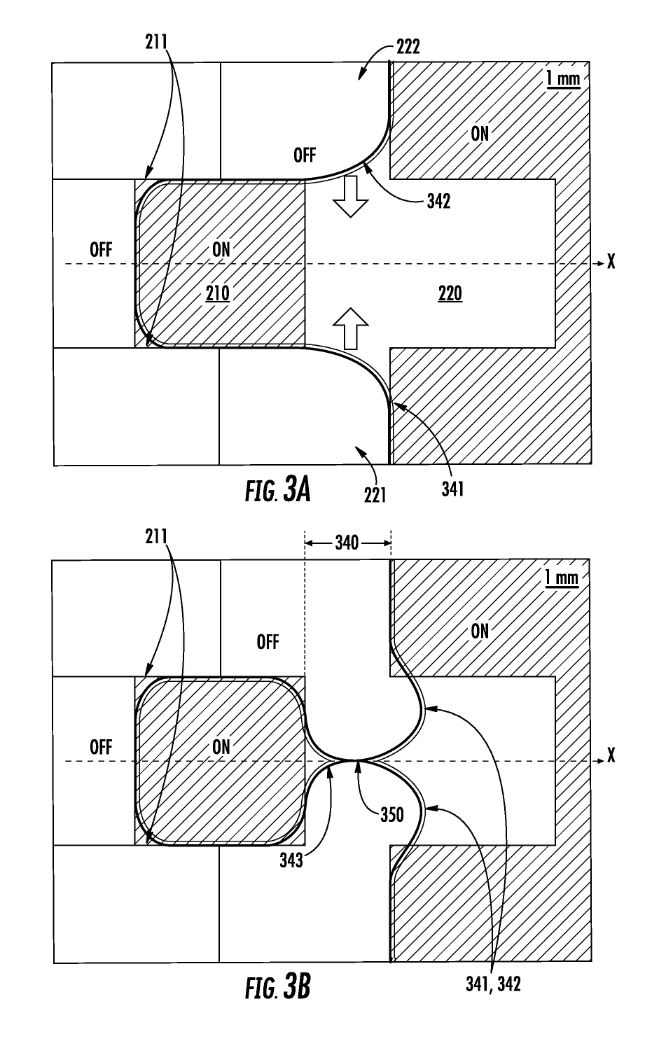

In contrast to the process of dispensing a droplet illustrated in FIG. 1, a droplet-dispensing component of a device described herein can provide consistent droplet volumes, as well as precise droplet volumes. FIG. 2 illustrates a droplet-dispensing component (100) according to one embodiment described herein. As illustrated in FIG. 2A, the droplet-dispensing component (200) comprises a droplet-generating electrode (210), a T-shaped electrode (220) contiguous with or immediately adjacent to the droplet-generating electrode (210), and a first C-shaped electrode (230) immediately adjacent to the T-shaped electrode (220). The droplet-dispensing component (200) of FIG. 2A also comprises a second C-shaped electrode (240) immediately adjacent to the first C-shaped electrode (230). Such an electrode structure, in some cases, can thus be referred to as a “TCC” structure or a “TCC reservoir.” (Similarly, it should be noted that other electrode structures that include a T-shaped electrode but that do not necessarily include one or more additional adjacent electrodes that are C-shaped, such as described hereinabove, may be referred to as a “T” structure (e.g., when only the T-shaped electrode is to be emphasized), a “TC” structure (e.g., when only one C-shaped electrode is present), or a “T-plus” structure (e.g., when there is at least one additional electrode adjacent to the T-shaped electrode, but the additional electrode is not necessarily C-shaped).)

A “C-shaped” electrode, for reference purposes herein, can be formed from or defined by a first segment, a second segment, and a third segment, wherein the segments are contiguous and the second and third segments are orthogonal or substantially orthogonal to the first segment and are spaced apart from one another in a direction corresponding to the long axis of the first segment. “Substantially” orthogonal segments or objects, for reference purposes herein, can define or be separated by an angle of about 80-100 degrees or about 85-95 degrees. In addition, in some embodiments, the second C-shaped electrode of a droplet-dispensing component described herein is larger than the first C-shaped electrode. Moreover, in some instances, the first C-shaped electrode and the second C-shaped electrode are nested.

A “T-shaped” electrode, for reference purposes herein, can be formed from two non-bisecting orthogonal segments having the same or differing lengths. Further, the first orthogonal segment can be of equal length and width on each side of the second orthogonal segment, as in the letter “T.” Moreover, in some cases, the second orthogonal segment of a T-shaped electrode has a long axis parallel to a droplet-dispensing direction of the droplet-dispensing component. In addition, it is to be understood that a T-shaped electrode may include a vacancy or “carve out,” as illustrated in FIG. 2A, wherein the vacancy is formed by the droplet-generating electrode (210). For example, in some instances, about one-third to two-thirds of the droplet-generating electrode “overlaps” with or forms a carve out from the T-shape of the T-shaped electrode. It is to be understood that a droplet-generating electrode that “overlaps” a T-shaped electrode is not stacked on top of the T-shaped electrode but instead is disposed within a region defined by a T-shape corresponding to the T-shaped electrode. In the embodiment of FIG. 2A, the droplet-generating electrode (210) is contiguous with the T-shaped electrode (220) and about one-half of the droplet-generating electrode (210) defines a carve out from the T-shaped electrode (220).

In some cases, the overlap of a droplet-generating electrode with the T-shape of a T-shaped electrode can affect the distance between the droplet-generating electrode and another electrode of the droplet-dispensing component, such as a reservoir electrode of the component. A “reservoir electrode,” as understood by one of ordinary skill in the art, refers to an electrode on which a reservoir fluid is disposed. Similarly, a “reservoir fluid” refers to a fluid that is used as the source of droplets formed or dispensed by the droplet-generating component. For example, in the embodiment of FIGS. 2A-G, the first and/or second C-shaped electrode can serve as or define a reservoir electrode, as described further below. Moreover, it is to be understood that a “reservoir fluid” can have a volume greater than the volume of an individual droplet dispensed by the component. In some cases, for example, a reservoir fluid has a volume that is at least 5 times, at least 10 times, at least 50 times, at least 100 times, or at least 1000 times the volume of an individual droplet dispensed by the component. A reservoir fluid can also have a volume that is between about 5 times and about 10,000 times, between about 5 times and about 1000 times, or between about 10 times and about 1000 times the volume of an individual droplet dispensed by the component. The distance between a reservoir electrode and a droplet-generating electrode, in some embodiments, can affect the radius of curvature (R) of a meniscus extending between the reservoir electrode and the droplet-generating electrode during droplet dispensing, including the radius of curvature of a tail described herein. In some cases, the distance between a reservoir electrode and a droplet-generating electrode is at least about 0.5 times the width of the droplet-generating electrode, where the distance is defined as the shortest distance in a droplet-dispensing direction (such as the direction parallel to axis “X” in FIG. 2A) between any portion of the droplet-generating electrode and any portion of the reservoir electrode. In some instances, the distance is between about 0.5 times and about 1.5 times the width of the droplet-generating electrode. In some embodiments, the distance is between about 0.5 mm and 5 mm, between about 0.5 mm and about 3 mm, or between about 1 mm and about 2 mm.

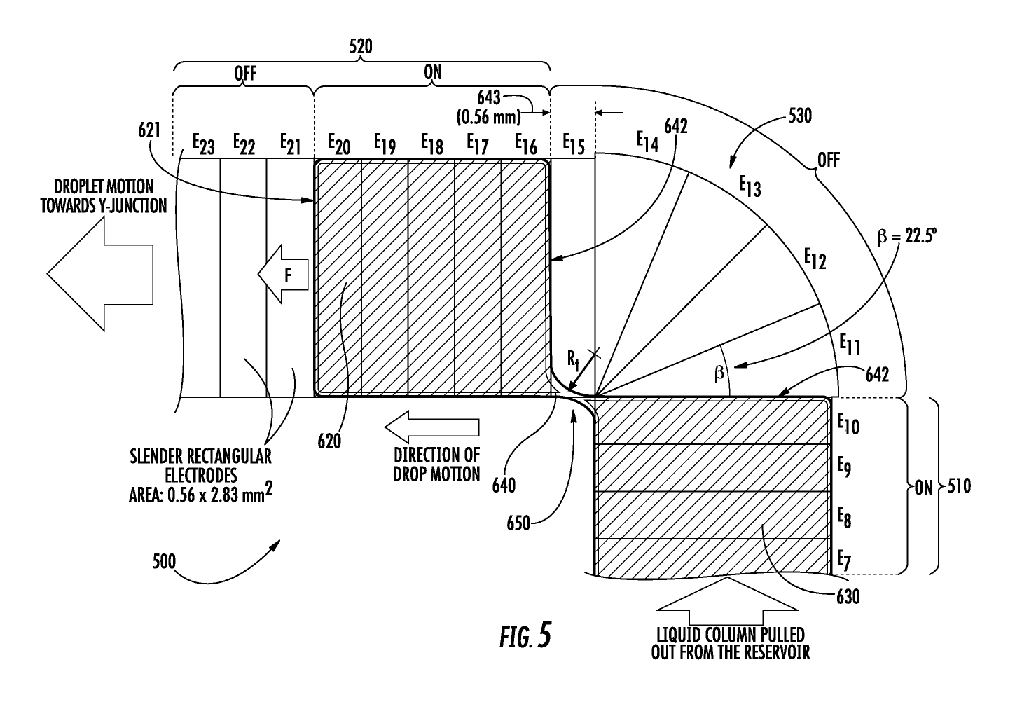

In addition, in some cases, the size and/or shape of a droplet-generating electrode can be selected to provide a desired distance between the droplet-generating electrode and a reservoir electrode. For example, in some instances, a sector shaped or “tear drop” shaped droplet-generating electrode is used to provide a separation distance of 0 mm, as illustrated in FIGS. 4A and 4B.

In general, a droplet-dispensing electrode of a droplet-dispensing component described herein can have any size and shape not inconsistent with the objectives of the present disclosure. In some embodiments, a droplet-generating electrode has a rounded shape. An electrode having a “rounded” shape, for reference purposes herein, does not include an acute interior angle or does not include more than one acute interior angle or more than one 90° interior angle. For example, in some cases, a droplet-generating electrode is circular or elliptical. A droplet-generating electrode can also be rectangular or square or have a rounded rectangular or rounded square shape, wherein one or more corners of the rectangle or square have been rounded. In addition, in some embodiments, a droplet-generating electrode described herein is sector shaped. Other shapes are also possible.

Additionally, in some cases, one or more of the droplet-generating electrode, the T-shaped electrode, the first additional (e.g., C-shaped) electrode, and the second additional (e.g., C-shaped) electrode of a droplet-dispensing component described herein is symmetric about an axis, such as an axis corresponding to the direction of movement of a droplet dispensed by the droplet-dispensing component. In some instances, the droplet-generating electrode, the T-shaped electrode, the first additional (e.g., C-shaped) electrode, and the second additional (e.g., C-shaped) electrode are all symmetric about a common axis, such as an axis corresponding to the droplet-dispensing direction or to the direction of tail formation, as illustrated by common axis X in FIGS. 2A-2G.

Again with reference to FIG. 2, a droplet-dispensing component (200) described herein, in some embodiments, can enable improved dispensing of individual droplets. FIGS. 2B-2G illustrate one exemplary method of dispensing a droplet using the droplet-dispensing component (200) of FIG. 2A. As illustrated in FIGS. 2B-2G, a fluid reservoir (310) is disposed on the first C-shaped electrode (230) and the second C-shaped electrode (240). To dispense a droplet (320) from the fluid reservoir (310), the droplet-generating electrode (210), the T-shaped electrode (220), and the second C-shaped electrode (240) are initially in an off state, and the first C-shaped electrode (230) is in an on state, as shown in FIG. 2B. Next, in FIG. 2C, the T-shaped electrode (220) is switched to an on state and the first C-shaped electrode (230) is switched to an off state, resulting in a portion of fluid (330) from the reservoir being pulled toward the T-shaped electrode (220). In FIG. 2D, the T-shaped electrode (220) remains in an on state and the droplet-generating electrode (210) is switched to an on state, resulting in coverage of the droplet-generating electrode (210) with the portion of fluid (330) drawn from the reservoir (310). Next, as shown in FIG. 2E, the T-shaped electrode (220) is switched to an off state and the first C-shaped electrode (230) and the second C-shaped electrode (240) are switched to an on state, while the droplet-generating electrode (210) remains in an on state. This electrode configuration results in the generation of two opposing forces (F₁, F₂) on the portion of fluid (330), further resulting in the formation of a tail (340) having menisci (341, 342) extending between the droplet (320) and the fluid reservoir (310). Continued application of the same voltages over time results in splitting of the tail (340) and withdrawal of the remaining portion of fluid (330) back into the fluid reservoir (310), leaving the droplet (320) on the droplet-generating electrode (210), as shown in FIG. 2F and FIG. 2G.

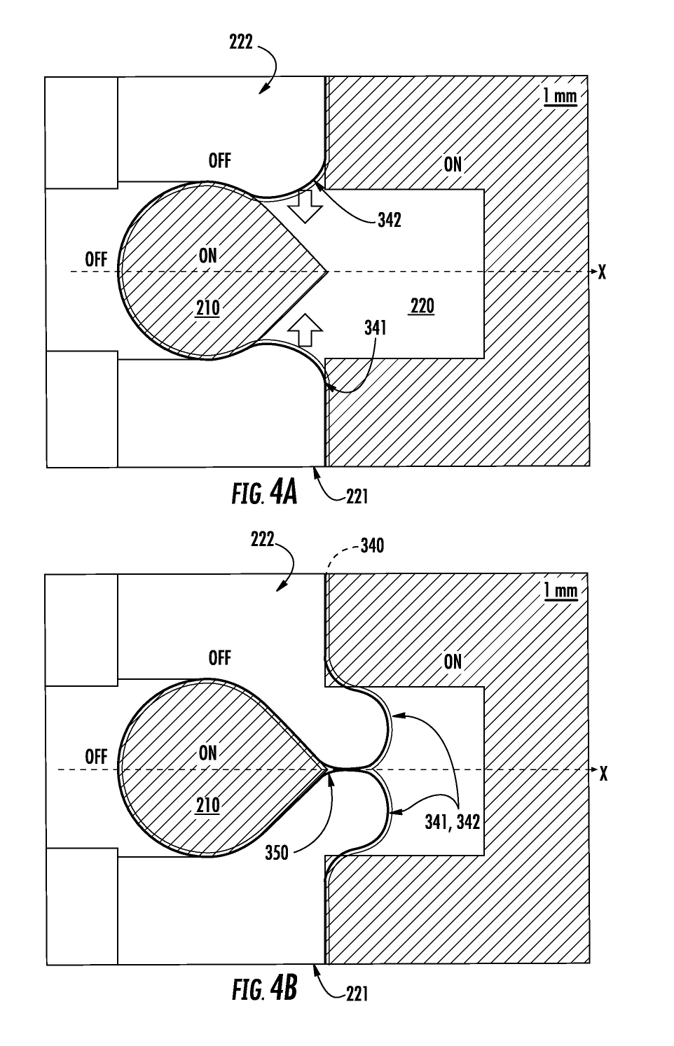

Not intending to be bound by theory, it is believed that the structure of the droplet-dispensing component (200) illustrated in FIGS. 2A-2G can provide droplets having consistent and precisely controlled volumes due to symmetric de-wetting of the electrodes of the component as a droplet is dispensed. With reference to FIGS. 3A-3B and FIGS. 4A-4B, it is believed that the symmetric arms (221, 222) of the T-shaped electrode (220) provide symmetric de-wetting of the fluid once the T-shaped electrode (220) is switched to an off state, as illustrated by the menisci (341, 342) traveling toward the middle of the T-shaped electrode (220) in the directions indicated by the arrows in FIG. 3A and FIG. 4A. Therefore, as shown in FIG. 3B and FIG. 4B, the menisci (341, 342) provide a consistent pinch off point (350) and a tail (340) having a short length (343) adjacent to the droplet-generating electrode (210). In FIGS. 3A-3B the droplet-generating electrode (210) has a square shape, while in FIGS. 4A-4B the droplet-generating electrode (210) has a tear drop shape. As described above, the tear drop shape of the droplet-generating electrode (210) in FIGS. 4A-4B can provide a distance of zero or nearly zero between the droplet-generating electrode (210) and the reservoir electrode, defined in part by the first C-shaped electrode (230) in the embodiment of FIGS. 4A-4B. As a result, the tail (340) has a length (343) of virtually zero adjacent to the droplet-generating electrode (210) in FIG. 4B.

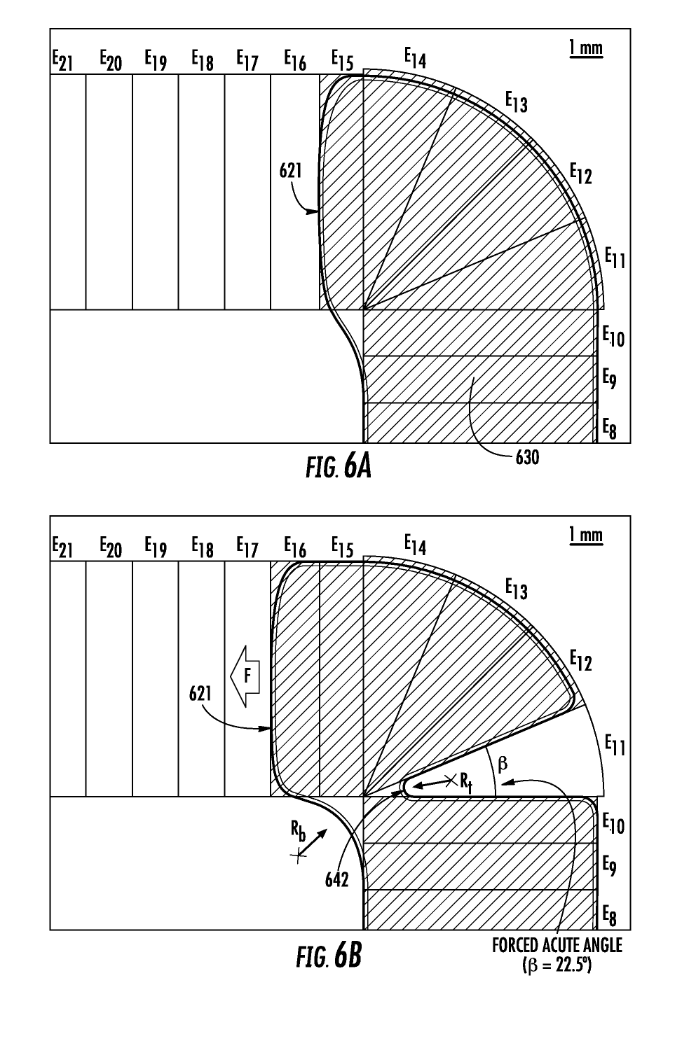

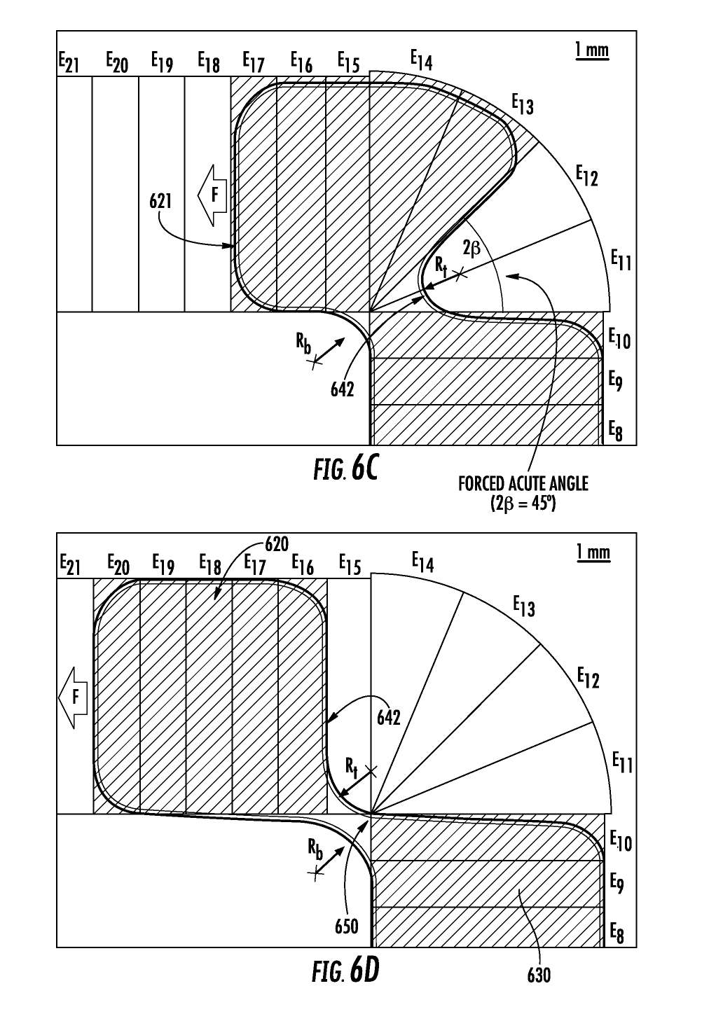

Another portion of an exemplary droplet-dispensing component described herein is illustrated in FIG. 5 and FIG. 6. With reference to FIG. 5, a droplet-dispensing component (500) comprises a first linear electrode segment (510), a second linear electrode segment (520), and a curved electrode segment (530) connecting the first linear electrode segment (510) and the second linear electrode segment (520). A “curved” electrode segment can refer to an electrode segment that subtends an angle other than 0 degrees or 180 degrees. Similarly, a “linear” electrode segment, for reference purposes herein, comprises an electrode segment that is not curved. Further, a curved or linear “segment” can be formed of or defined by one electrode or a plurality of electrodes.

As illustrated in FIG. 5, the first linear electrode segment (510) of the component (500) is formed from a plurality of contiguous electrodes (E₇, E₈, E₉, E₁₁)) having the same shape and area. Although the first linear electrode segment (510) is shown as including four electrodes (E₇, E₈, E₉, E₁₁)), it is to be understood that a first linear electrode segment can comprise or be formed by any number of contiguous electrodes not inconsistent with the objectives of the present disclosure. Similarly, the second linear electrode segment (520) of the component (500) in FIG. 5 is formed from a plurality of contiguous electrodes (E₁₅, E₁₆, E₁₇, E₁₈, E₁₉, E₂₀, E₂₁, E₂₂, E₂₃), but it is to be understood that a second linear electrode segment of a droplet-dispensing component described herein can comprise or be formed by any number of contiguous electrodes not inconsistent with the objectives of the present disclosure. Moreover, as illustrated in FIG. 5, the contiguous electrodes of the first (510) and second (520) linear electrode segments are rectangular. Further, the contiguous electrodes have the same size and shape. In particular, the contiguous electrodes comprise rectangles having a width of about 0.56 mm and a length of about 2.8 mm. However, other sizes and shapes are also possible. In some cases, for example, contiguous rectangular electrodes have a width of about 0.1 to about 2 mm, about 0.1 to about 1 mm, about 0.2 to about 0.8 mm, or about 0.3 to about 0.8 mm, and a length of about 1 to about 10 mm, about 1 to about 5 mm, about 2 to about 10 mm, or about 2 to about 5 mm. The aspect ratio of contiguous electrodes of a droplet-dispensing component described herein can be about 1.5 to 10, about 2 to 10, about 3 to 10, about 4 to 10, about 4 to 8, about 5 to 10, or about 5 to 8. Contiguous electrodes of a linear electrode segment can also have other shapes, such as square shapes.

In contrast to the linear electrode segments (510, 520), the curved electrode segment (530) of FIG. 5 is formed from a plurality of circular sector-shaped electrodes (E_{H}, E₁₂, E₁₃, E₁₄). Further, the sector-shaped electrodes are contiguous, have the same area, and subtend the same angle (β=22.5°). In addition, the sector-shaped electrodes have the same area as the rectangular electrodes of the first and second linear electrode segments (510, 520). Further, in the embodiment of FIG. 5, the portion of the droplet-dispensing component (500) formed by the first linear electrode segment (510), the second linear electrode segment (520), and the curved electrode segment (530) is L-shaped. Specifically, as illustrated in FIG. 5, the curved electrode segment (530) subtends an angle of about 90 degrees. However, it is to be understood that other angles are also possible. For example, in some instances, the curved electrode segment (530) subtends an angle of about 60 to 120 degrees, 70 to 110 degrees, 80 to 100 degrees, or 85 to 95 degrees. In general, such a structure, in some cases, can be referred to as an “L-junction” or an L-junction electrode structure.

A droplet-dispensing component (500) having a structure described above can be used to dispense droplets more rapidly and/or with improved volume precision and/or consistency, as compared to some other droplet-dispensing components. Not intending to be bound by theory, it is believed that improved volume precision and/or consistency, and/or increased speed of dispensing a droplet can be achieved by forcing a portion of a fluid reservoir to form an acute angle or substantially acute angle during de-wetting and movement of the portion over the curved electrode segment. This process is illustrated in FIG. 5 and FIGS. 6A-6D. With reference to FIG. 5, electrodes E₇-E₁₀ and E₁₆-E₂₀ are in an on state, and electrodes E₁₁-E₁₅ and electrodes E₂₁-E₂₃ are in an off state. As a result, a front meniscus of fluid (621) moves over electrodes E₁₅-E₂₀ of the second linear electrode segment (520), and a de-wetting meniscus (642) follows over electrodes E₁₁-E₁₄ of the curved electrode segment (530). Again not intending to be bound by theory, it is believed that the forced acute angle of the electrodes E₁₁-E₁₄ forces the de-wetting meniscus (642) to form a small radius of curvature (Rₜ) at the “top” of the de-wetting meniscus (642) (which may also be referred to as the “top de-wetting meniscus”), the radius of curvature (Rₜ) corresponding to the angle subtended by the top of the de-wetting meniscus (642), which corresponds approximately to the total angle subtended by the electrodes of the curved electrode segment (530) that are in an off state. The small radius of curvature (Rₜ) in turn creates a higher pressure on the outside of the portion of fluid (630) over the curved electrode segment (530), resulting in a rapid and precise pinching off of the portion (630) to form the droplet (620). Pinching off occurs at a precise pinch-off point (650), and only a very small tail (640) is formed. Additionally, the pinching off occurs over a very short “cutting” or pinching length (643), corresponding in the embodiment of FIG. 5 to the width of a single electrode (E₁₅) of the second linear electrode segment (520). Further, it should be noted that this rapid and precise pinching off is obtained while a force is applied to the fluid in only one direction, as indicated by the arrow (F) in FIG. 5. Additionally, it should be noted that the de-wetting direction is parallel with the droplet-dispensing direction.

The droplet-dispensing process of FIG. 5 is further illustrated in FIGS. 6A-6D. In FIG. 6A, electrodes E₈-E₁₅ are in an on state, and electrodes E₁₆-E₂₁ are in an off state. At this stage of the process, the portion of fluid (630) drawn from the reservoir is beginning to take a turn over the right angle defined by the first linear electrode segment (510), the second linear electrode segment (520), and the curved electrode segment (530). In FIG. 6B, which corresponds to a later stage in the process, electrodes E₈-E₁₀ and E₁₂-E₁₆ are in an on state, and electrodes E₁₁ and electrodes E₁₇-E₂₁ are in an off state. At this stage of the process, the de-wetting meniscus (642) exhibits a radius of curvature (Rₜ) at the top of the meniscus (642) corresponding to a forced acute angle of about 22.5 degrees, which is equal to the sum of the angle subtended by the sector-shaped electrode E₁₁ in the off state. Moreover, there is also a radius of curvature (R_{b}) at the “bottom” of the de-wetting meniscus (642) (which may also be referred to as the “bottom de-wetting meniscus”). The radius of curvature (R_{b}) at the bottom of the meniscus (642) is larger than the radius of curvature (Rₜ) at the top of the meniscus (642). In FIG. 6C, which again corresponds to a later stage in the process, electrodes E₈-E₁₀ and E₁₃-E₁₇ are in an on state, and electrodes E₁₁ and E₁₂ and electrodes E₁₈-E₂₁ are in an off state. At this stage of the process, the top of the de-wetting meniscus (642) exhibits a radius of curvature (Rₜ) corresponding to a forced acute angle of 45 degrees, which is equal to the sum of the angles subtended by the sector-shaped electrodes E₁₁ and E₁₂ in the off state. However, unlike the radius of curvature (Rₜ) at the top of the meniscus (642), the radius of curvature (R_{b}) at the bottom of the meniscus (642) has not changed in FIG. 6C. In FIG. 6D, which corresponds to a still later stage in the process, electrodes E₈-E₁₀ and E₁₆-E₂₀ are in an on state, and electrodes E₁₁-E₁₅ are in an off state, as in FIG. 5. The stage of the process depicted in FIG. 6D is temporally near the pinching off event, such that the dispensed droplet (620) is well defined and is nearly separated from the portion of fluid (630).

Not intending to be bound by theory, it is believed that a droplet-dispensing component such as that illustrated in FIGS. 5 and 6 provides improved droplet volume precision and consistency and/or increased droplet dispensing speed as follows. While liquid flow proceeds from the reservoir region of the device and into the droplet generating region as described herein, it is believed that the de-wetting meniscus is forced to be confined within very small electrode segments over the curved electrode segment, thereby defining a narrow cutting length. More particularly, it is believed that precise and high speed droplet pinch-off occurs due to the higher pressure drop induced by the EWOD force within the small electrode segments, which are oriented “upstream” (i.e., away from the direction of liquid flow) of the emerging droplet. As a result of the L-shaped architecture of the electrodes, the liquid neck or tail of the portion of fluid drawn from the reservoir becomes increasingly narrow, eventually “breaking” or pinching off to form a dispensed droplet. The Laplace pressure drop at a point A in this process is given by the Young-Laplace equation, which may be expressed according to Equation (1) below:

$$Δ {P}_{L} = {γ}_{LG} [ \frac{1}{{r}_{A}} + \frac{1}{{R}_{t}} ] = [ \frac{1}{{r}_{A}} - \frac{1}{\vert {R}_{t} \vert} ] , \qquad ( 1 )$$

wherein ΔP_{L} is the Laplace pressure drop at the point A, γ is the surface tension, r_{A} is the radius of curvature at the point A, and Rₜ is as defined above. With reference to FIGS. 6B and 6C, between the first (FIG. 6B) and second (FIG. 6C) steps of the process of droplet formation, the Laplace pressure drop across the top de-wetting meniscus increases because the radius of curvature (Rₜ) increases. As a result, the width of the neck between the portion of fluid (630) and the eventual droplet (620) thins. The Laplace pressure drop across the top de-wetting meniscus increases linearly with switching time until the droplet pinches off. At the instance of pinch-off, since r_{A} approaches zero, the Laplace pressure drop reaches a maximum value. Further, since the bottom de-wetting meniscus is fixed and its radius of curvature (R_{b}) is not changing, the Laplace pressure drop across the bottom de-wetting meniscus remains the same throughout the process of formation of the droplet. After the pinch-off, the dispensed droplet moves downstream while the front end of the reservoir liquid column remains at the edge of the electrode E₁₀. Thus, using an L-junction described herein, before pinch-off occurs, the Laplace pressure drop across the de-wetting meniscus from both sides has reached the same maximum value. This condition can be achieved when both top and bottom menisci are confined within right angles such that the pinch-off point occurs at the tip of the L-junction. If the curved electrode segment subtends an angle that is too acute, Laplace pressure drop across the bottom de-wetting meniscus will be lower than that of the top de-wetting meniscus, and the location of pinch-off will occur below the pinch-off point described above. If the curved electrode segment subtends an angle that is too obtuse, the Laplace pressure drop across the bottom de-wetting meniscus will be higher than that of the top de-wetting meniscus, and the location of pinch-off will occur above the pinch-off point described above. In both cases, the liquid tail will be larger than in the case when pinching off occurs at the pinch-off point described above, resulting in relatively poor volume precision and consistency.

Again not intending to be bound by theory, it is further believed that the use of contiguous electrodes as described herein in a droplet-dispensing component, including but not limited to a droplet-dispensing component having a L-junction, can minimize the deformation of the fluid moving across the electrodes and thereby maximize the speed of the head/front meniscus of the liquid and the speed of de-wetting.

Various portions and features of droplet-dispensing components have been described herein. It is to be understood that a droplet-dispensing component described herein can include any combination of features not inconsistent with the objectives of the present disclosure. In some cases, for instance, the droplet-generating electrode (210) of the droplet-dispensing component (200) of FIG. 2A comprises or corresponds to the first linear electrode segment (510) or the second linear electrode segment (520) of the droplet-dispensing component (500) of FIG. 5. Thus, in some embodiments, a droplet-dispensing component described herein comprises a droplet-generating electrode, a T-shaped electrode adjacent to the droplet-generating electrode, a first C-shaped electrode adjacent to the T-shaped electrode, and a second C-shaped electrode adjacent to the first C-shaped electrode, wherein the droplet-generating electrode comprises a first linear electrode segment, such as a first linear electrode segment described hereinabove. Moreover, in some instances, a DMF device described herein further comprises a second linear electrode segment and a curved electrode segment connecting the first linear electrode segment to the second linear electrode segment. In some such embodiments, the curved electrode segment subtends an angle of about 90 degrees. In other cases, the first linear electrode segment (510) of the droplet-dispensing component (500) of FIG. 5 corresponds to a reservoir electrode or reservoir region, and the second linear electrode segment (520) acts as the droplet-generating electrode or droplet generating region. Additionally, it is to be understood that an L-junction described herein can be used with any reservoir size, reservoir design, and/or reservoir volume not inconsistent with the objectives of the present disclosure. Moreover, one or more advantages of the L-junction (such as improved droplet dispensing precision, consistency, and/or speed) can be independent of the specific reservoir size, design, and/or volume. Other combinations of components are also possible.

As described above, droplet-dispensing components of a DMF device described herein, in some cases, can provide reduced variation in unit droplet and/or reduced time to dispense a droplet. In some instances, for example, a device described herein can provide a volume precision and/or consistency of ±10% or less, ±5% or less, ±1% or less, ±0.5% or less, or ±0.1% or less, where the percentage is based on the volume subtended by a droplet-generating electrode described herein (in the case of volume precision) or on the standard deviation of the volumes of a population of 10 to 100, 100 to 1000, or 1000 to 10,000 sequentially dispensed droplets (in the case of volume consistency). In some embodiments, the volume precision of a device described herein is about 1-20%, about 1-10%, about 1-5%, or about 1-3%. The volume consistency of a device described herein can be about 0.05-10%, about 0.05-5%, about 0.05-1%, about 0.1-10%, about 0.1-1%, about 0.5-10%, about 0.5-5%, about 0.5-1%, about 1-5%, or about 1-3%. Additionally, in some cases, a device described herein has a droplet-dispensing speed of less than about 100 ms, less than about 50 ms, less than about 30 ms, less than about 20 ms, or less than about 15 ms per droplet. In some instances, the droplet-dispensing speed is about 5-100 ms, 5-50 ms, 10-100 ms, 10-50 ms, 10-30 ms, or 10-20 ms per droplet. Moreover, such a dispensing speed, in some cases, can be obtained in an air environment at an applied voltage of 80-150 V, such as an applied voltage of 125 V. In some embodiments, an applied voltage of less than about 80 V, less than about 60 V, less than about 50 V, or less than about 20 V may also be used. In general, the applied voltage is sufficient to provide wetting of the device surface with fluid for a given device architecture. Similarly, it is to be understood that devices described herein can be used with an oil medium or other medium rather than an air medium. In such instances, rapid, precise, and consistent droplet-dispensing can still be obtained.

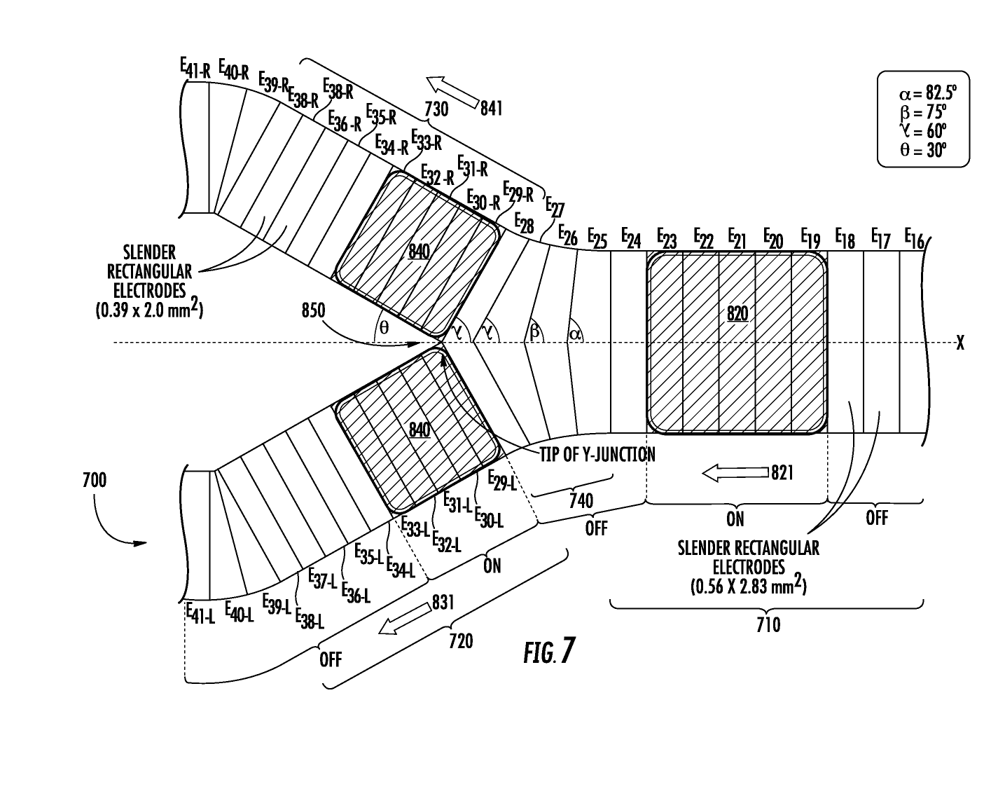

In addition to droplet-dispensing components, droplet-splitting components of a DMF device are also described herein. One non-limiting example of a droplet-splitting component described herein is illustrated in FIG. 7. With reference to FIG. 7, a droplet-splitting component (700) of a DMF device comprises a first linear electrode segment (710), a second linear electrode segment (720), a third linear electrode segment (730), and a Y-junction electrode segment (740) connecting the first linear electrode segment (710) to the second (720) and third (730) linear electrode segments. Further, in the embodiment of FIG. 7, the first linear electrode segment (710), the second linear electrode segment (720), the third linear electrode segment (730), and the Y-junction electrode segment (740) form a Y-shape. Thus, such a droplet-splitting component can be referred to generally as a “Y-junction.” Additionally, the Y-shape and the first linear electrode segment (710) are symmetric about a common axis (“X” in FIG. 7). The axis X corresponds to a direction of movement of a droplet (821) split by the droplet-splitting component (700). Further, in the embodiment of FIG. 7, the second (720) and third (730) linear electrode segments form the arms of the Y-shape. Moreover, the second (720) and third (730) linear electrode segments define an acute angle. Specifically, the second (720) and third (730) linear electrode segments define an angle of 60 degrees (20 in FIG. 7). Other angles are also possible. The use of an acute angle at the Y-junction of a droplet-splitting component described herein, in some embodiments, can permit a droplet to be split without the need to redirect the droplet in a direction orthogonal to the droplet's original direction of motion. For example, as illustrated in FIG. 7, the droplet (820) initially traveling over the first linear electrode segment (710) in a first direction (821) is split into a first droplet portion (830) traveling in a second direction (831) and a second droplet portion (840) traveling in a third direction (841). The second (831) and third (841) directions are not orthogonal to each other or to the first direction (821). Instead, the second (831) and third (841) directions form an acute angle with one another and with the first direction (821). In this manner, a substantial portion of the linear momentum of the droplet (820) can be preserved throughout the splitting process, thereby increasing the speed and efficiency of splitting. For example, in some cases, a droplet-splitting component described herein can split a droplet at a speed corresponding to a droplet-dispensing speed described above. Moreover, the droplet-splitting speed can be matched to the droplet-dispensing speed for a particular device architecture, such as a device architecture including both an L-junction and a Y-junction.

In addition, the speed and/or efficiency of droplet splitting can be further improved by forming the first, second, and/or third linear electrode segments (710, 720, 730) from a plurality of contiguous electrodes, such as a plurality of contiguous rectangular electrodes (E₁₆-E₂₄, E_{29-L} through E_{38-L}, and E_{29-R} through E_{38-R} in the exemplary embodiment of FIG. 7). Moreover, contiguous rectangular electrodes of the second linear electrode segment (E_{29-L} through E_{38-L} in the exemplary embodiment of FIG. 7) can be in electrical communication with the corresponding contiguous rectangular electrodes of the third linear electrode segment (E_{29-R} through E_{38-R} in the exemplary embodiment of FIG. 7), such that both sets of electrodes are switched on and off together in a synchronized manner. Further, as described hereinabove, such contiguous electrodes can be narrow or slender electrodes, including electrodes having a size and/or aspect ratio described above. The contiguous electrodes may also have the same area or substantially the same area as one another. Not intending to be bound by theory, it is believed that the use of such contiguous electrodes, in some cases, can minimize the deformation of the fluid moving across the electrodes and thereby maximize the speed of the head/front meniscus of the liquid and the speed of de-wetting.

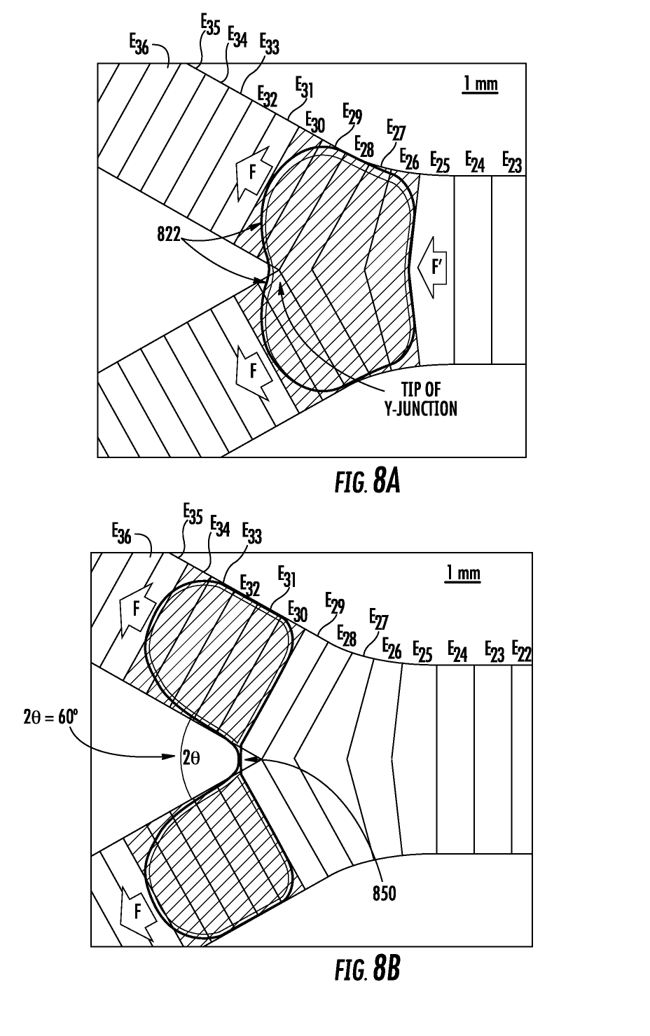

Similarly, the Y-junction electrode segment (740) may also be formed from a plurality of contiguous electrodes (E₂₅-E₂₈ in the exemplary embodiment of FIG. 7). Moreover, the contiguous electrodes (E₂₅-E₂₈) can be angled electrodes. An “angled” electrode or electrode segment can refer to an electrode or segment that defines or forms a polygon having more than four sides and having at least one obtuse angle. In addition, an angled electrode or segment described herein can be symmetric about an axis described herein, including an axis corresponding to the motion of a droplet to be split by the droplet-splitting component. In some instances, the axis of symmetry bisects the largest interior angle of the electrode. The largest interior angle of an angled electrode may also “point” toward the second and third linear electrode segments. Further, in some cases such as that illustrated in FIG. 7, the largest interior angles formed by the angled electrodes decrease from the first linear segment (710) toward the second (720) and third (730) linear segments. For example, in the embodiment of FIG. 7, the obtuse interior angles subtended by the angled electrodes E₂₅-E₂₈ in FIG. 7 decrease from 165° to 150° to 120°. Other configurations are also possible. A droplet-dispensing component (700) having such a structure, in some embodiments, can provide a consistent pinch-off point (850) for splitting a droplet (820), as illustrated in FIGS. 8A and 8B. In FIG. 8A, electrodes E₂₆-E₃₀ are in an on state, and electrodes E₂₃-E₂₅ and electrodes E₃₁-E₃₆ are in an off state. At this stage of the process, the front meniscus (822) contacts the pinch-off point (850). In FIG. 8B, which corresponds to a later stage in the droplet-splitting process, electrodes E₃₀-E₃₄ are in an on state, and electrodes E₂₂-E₂₉ and E₃₅-E₃₆ are in an off state. It is generally to be understood that figures depicting specific electrodes do not necessarily depict each and every electrode in a DMF device or component of a DMF device. Instead, the figures depict electrodes sufficient to enable understanding of the devices and/or components. As understood by one of ordinary skill in the art, other electrodes and processes of switching electrode states are also possible.

Similarly, it is to be understood that the present invention is not limited to the precise structures depicted in the figures and examples, such as the “TCC,” “L-junction,” or “Y-junction” structures described above. Other specific structures may also be used consistent with the objectives of the present disclosure, as described further hereinbelow in Section II and Section III.

In addition, it is to be understood that droplet-splitting and droplet-dispensing components described herein may be used in conjunction with one another. For example, in some cases, a droplet-dispensing component such as that illustrated in FIG. 2A or FIG. 5 can provide a droplet to the first linear segment (710) of the droplet-splitting component (700) in FIG. 7. Other combinations of components are also possible. Moreover, it is also possible to use a droplet-dispensing and/or droplet-splitting component described herein to provide droplets to an apparatus external to the DMF device. For example, in some cases, a droplet-dispensing and/or droplet-splitting component of a DMF device described herein provides droplets or droplet portions to a PCR apparatus.

Further, in addition to a droplet-dispensing component and/or a droplet-splitting component described above, a DMF device described herein can also comprise other components. For example, in some cases, a DMF device described herein comprises a first parallel plate, a second parallel plate in facing opposition to the first parallel plate, and a gap between the first and second parallel plates. Fluid droplets can be formed and/or manipulated in the gap while in contact with the first and/or second parallel plate. Moreover, the first and/or second parallel plate can comprise a substrate, electrical contacts or electrodes positioned on or over the substrate, a dielectric layer positioned over the electrodes and substrate, and a hydrophobic coating positioned on the dielectric layer. A droplet disposed between the plates can be in contact with the topmost layer, such as the dielectric layer or hydrophobic coating, of each plate. A first parallel plate, second parallel plate, substrate, electrode, dielectric layer, and/or hydrophobic coating of a DMF device described herein can be formed from any material not inconsistent with the objectives of the present disclosure. For example, in some instances, a substrate of a DMF device is formed of a glass such as a glass made of soda-lime, a borosilicate, an aluminosilicate, a titanium silicate, pure silica, or quartz. Further, in some embodiments, electrodes are formed from a highly conductive material such as a metal or metal alloy or mixture of metals. For example, in some instances, electrodes are formed from chromium, gold, silver, copper, aluminum, indium, or a combination or mixture thereof. Electrodes may also be formed from a conductive oxide such as a transparent conductive oxide (TCO). Non-limiting examples of transparent conductive oxides suitable for use in some embodiments described herein include indium tin oxide (ITO), gallium indium tin oxide (GITO), and zinc indium tin oxide (ZITO). A dielectric layer, in some instances, is formed from an inorganic material such as a ceramic, which may include a silicon nitride (SiN). A dielectric layer may also be formed of an organic dielectric material such as a poly(p-xylylene) or parylene (including Parylene C). A dielectric photoresist such as SU-8 may also be used as a dielectric layer in some embodiments described herein. Similarly, any hydrophobic coating not inconsistent with the objectives of the present disclosure may be used in a DMF device described herein. In some cases, for instance, a poly(tetrafluoroethylene) or Teflon material is used. Substrates, electrodes, dielectric layers, and hydrophobic coatings formed from other materials are also possible.

Moreover, in some embodiments, a DMF device described herein does not include or comprise a capacitive feedback component, such as a capacitive feedback component comprising a thin film capacitor, an electrode for measuring capacitance, a processor, and/or a signal I/O capacity structure to perform feedback control.

Further, a device described herein can be made in any manner not inconsistent with the objectives of the present disclosure. In some instances, for example, a DMF device described herein is fabricated in a cleanroom using layer-by-layer microfabrication. As understood by one of ordinary skill in the art, such a process, in some embodiments, can comprise one or more blanket depositing steps (e.g., to deposit ITO on a glass substrate), one or more evaporating steps (e.g., to deposit a metal electrode), one or more chemical or physical vapor deposition steps (e.g., to deposit a ceramic dielectric material), and one or more patterning, masking, and/or etching steps, including one or more photolithographic steps (e.g., to define one or more electrodes or functional structures of the device). One or more spin-coating or casting steps may also be used (e.g., to deposit a hydrophobic coating on a dielectric layer).

### II. Methods of Dispensing a Droplet in a Digital Microfluidic Device

In another aspect, methods of dispensing a droplet in a DMF device are described herein. In some embodiments, a method of dispensing a droplet in a DMF device comprises dispensing the droplet from a reservoir fluid of the DMF device. Accordingly, some features of methods described herein can be understood with reference to FIGS. 1-8.

In some instances, a method described herein comprises covering a droplet-generating electrode of a DMF device with a portion or “finger” of a reservoir fluid, wherein the portion has a larger area than the droplet-generating electrode. The method further comprises withdrawing the portion of the reservoir from the droplet-generating electrode while the droplet-generating electrode is in an on state to form a droplet on the droplet-generating electrode, wherein the area of the droplet is substantially the same as the area of the droplet-generating electrode. The “area” of a droplet, portion of reservoir fluid, or electrode, for reference purposes herein, refers to the planar area, as opposed to a total surface area. Further, the planar area corresponds to the plane of the surface on which the fluid is disposed. In addition, areas that are “substantially” the same have areas that differ by no more than about 10 percent, no more than about 5 percent, no more than about 3 percent, no more than about 1 percent, or no more than about 0.5 percent, the percent being based on the larger area. Moreover, in some embodiments of a method described herein, the volume of the droplet is less than half of the total volume of the portion of the reservoir fluid used to cover the droplet-generating electrode.

The steps of covering a droplet-generating electrode with a portion of a reservoir fluid and subsequently withdrawing the portion are illustrated in FIG. 2, with particular reference to FIGS. 2D-2G. As illustrated in FIG. 2D, the droplet-generating electrode (210) of the device of FIG. 2A is covered with a portion of reservoir fluid (330). As illustrated in FIGS. 2E-2G, the portion (330) is withdrawn from the droplet-generating electrode (210) while the droplet-generating electrode (210) is in an on state to form a droplet (320) on the droplet-generating electrode (210).

In the embodiment of FIG. 2, the droplet-generating electrode (210) has a square shape. However, other shapes are also possible. For example, in some cases, the droplet-generating electrode has a rounded shape, such as a circular shape, a sector shape, or another rounded shape described hereinabove in Section I. More generally, it is to be understood that a method of dispensing a droplet described herein, in some embodiments, can be carried out using a device having a structure described hereinabove in Section I. For example, in some instances, a method of dispensing a droplet described herein is carried out using a droplet-dispensing component comprising a TCC electrode structure and/or an L-junction electrode structure.

Additionally, the steps of a method described herein can be carried out in any manner not inconsistent with the objectives of the present disclosure. In some embodiments, for instance, the droplet-generating electrode is covered with the portion of the reservoir fluid by switching the droplet-generating electrode and one or more additional electrodes immediately adjacent to the droplet-generating electrode to an on state, as illustrated in FIG. 2. For example, in some embodiments, the reservoir fluid can be disposed on a reservoir electrode (such as electrodes 230 and 240 in FIG. 2), and the reservoir electrode can be separated from the droplet-generating electrode by one or more additional electrodes (such as electrode 220 in FIG. 2). To cover the droplet-generating electrode with a portion of the reservoir fluid, the reservoir electrode can be switched to an off state and the droplet-generating electrode can be switched to an on state (such as in FIG. 2D). If desired, one or more additional electrodes immediately adjacent to the droplet-generating electrode may also be switched to an on state (such as electrode 220 in FIG. 2D). A droplet-generating electrode can be covered with a portion of a reservoir fluid in other manners as well. Similarly, in some instances, withdrawing the portion of the reservoir fluid from the droplet-generating site comprises switching the reservoir electrode from an off state to an on state (as illustrated, for example, in FIGS. 2E-2G). Additionally, as described above, withdrawing the portion of the reservoir fluid from the droplet-generating electrode can also comprise forming a tail extending between the droplet and the reservoir fluid.

In other embodiments, a method of dispensing a droplet from a reservoir fluid of a DMF device is described herein, wherein the method comprises providing a droplet-generating electrode having a rounded shape and switching the droplet-generating electrode to an on state to form the droplet on the droplet-generating electrode, wherein the droplet-generating electrode being adjacent to the reservoir fluid. Moreover, the reservoir fluid, in some cases, can be disposed on a reservoir electrode, and the method can further comprise switching the reservoir electrode to an off state, including at the same time or substantially the same time as the droplet-generating electrode is switched to the on state. Additionally, in some embodiments, the area of the droplet is substantially the same as the area of the droplet-generating electrode. Any droplet-generating electrode having a round shape described hereinabove in Section I may be used in a method described herein. In some cases, for instance, the droplet-generating electrode has a circular shape. Dispensing a droplet in a manner described herein, in some cases, can reduce the amount of “empty” or “unused” area of a droplet-generating electrode, thus permitting more efficient droplet formation and the formation of droplets having more precise and consistent volumes corresponding to the volume subtended by the known area of the droplet-generating electrode. FIGS. 3A and 3B, which include a square drop-generating electrode (210) rather than a rounded drop-generating electrode, illustrate such “empty” or unused areas (211). In contrast, as described further hereinabove, the droplet-generating electrode (210) of FIGS. 4A and 4B has a tear drop shape and thus is free of empty or unused space.

In still other embodiments, a method of dispensing a droplet from a reservoir fluid of a DMF device is described herein, wherein the method comprises removing a portion of the reservoir fluid to form a droplet and a tail extending between the droplet and the reservoir fluid, forming at least one fixed meniscus of the reservoir fluid adjacent to the tail, and forming a fixed meniscus of the droplet adjacent to the tail, wherein the fixed meniscus of the reservoir fluid is substantially parallel to the fixed meniscus of the droplet. Alternatively, in other embodiments, the fixed meniscus of the reservoir fluid is substantially orthogonal to the fixed meniscus of the droplet. Additionally, in some cases, a method described herein further comprises splitting the tail to divide the droplet from the reservoir fluid. Moreover, in some instances, the curvature of the reservoir fluid adjacent to the tail and the curvature of the droplet adjacent to the tail are each infinite. Further, in some embodiments, two fixed menisci of the reservoir fluid are formed adjacent to the tail, and the two fixed menisci are substantially parallel to one another. “Substantially” parallel menisci, for reference purposes herein, are within about 10 degrees, within about 5 degrees, or within about 1 degree of a parallel configuration.

The alignment of menisci according to one embodiment of a method described herein is illustrated in FIG. 2. With reference to FIG. 2A, fixed menisci on the first C-shaped electrode (230) are defined by the parallel lines y_{1B} and y_{2B}. Further, the fixed menisci y_{1B} and y_{2B} are also parallel to a fixed meniscus of the portion of fluid (330) removed from the fluid reservoir (310). The latter fixed meniscus is represented by line segment d of the abcd square of the droplet-generating electrode (210). As a result, the curvature of the reservoir fluid (310) adjacent to the tail (340) and the curvature of the droplet (320) adjacent to the tail (340) are each infinite. Additionally, as illustrated in FIGS. 3A and 3B, the de-wetting menisci (341, 342) move symmetrically toward one another and pinching off always occurs at a fixed point (350). Thus, as described above, dispensing a droplet in a manner described herein can provide droplets having consistent and precise volumes.

Various methods of dispensing a droplet have been described herein. However, it is to be understood that steps of methods of dispensing a droplet described herein can be combined in any manner not inconsistent with the objectives of the present disclosure. For example, in some instances, a droplet is formed by providing a droplet-generating electrode having a rounded shape and switching the droplet-generating electrode to an on state to form the droplet on the droplet-generating electrode, wherein forming the droplet on the droplet-containing electrode comprises covering the droplet-generating electrode with a portion of the reservoir fluid having a larger area than the droplet-generating electrode. Moreover, in some such embodiments, forming the droplet on the droplet-generating electrode can further comprise withdrawing the portion of the reservoir fluid from the droplet-generating electrode while the droplet-generating electrode is in the on state. Further, in some cases, the distance between the droplet-generating electrode and the reservoir electrode has a value described hereinabove in Section I.

Moreover, it is to be understood that a method of dispensing a droplet described herein, in some cases, can be carried out using any device structure described hereinabove in Section I, not only the device structure of FIGS. 2 and 3. For example, in some instances, a method of dispensing a droplet described herein is carried out using a device comprising a droplet-dispensing component described hereinabove, such as a droplet-dispensing component comprising a TCC electrode structure and/or an L-junction electrode structure. In some embodiments, therefore, a method of dispensing a droplet described herein comprises providing a digital microfluidic device comprising a droplet-dispensing component, wherein the droplet-dispensing component comprises a first linear electrode segment, a second linear electrode segment, and a curved electrode segment connecting the first linear electrode segment and the second linear electrode segment. In some cases, the curved electrode segment subtends an angle of about 90 degrees. Other angles are also possible, as described in Section I hereinabove. Moreover, the method further comprises forcing a portion of a fluid reservoir of the device to form an acute angle during de-wetting and movement of the portion over the curved electrode segment. Additionally, in some instances, forcing the portion of the fluid reservoir to form the acute angle comprises forcing a de-wetting meniscus of the portion to form a small radius of curvature corresponding to the angle subtended by the curved electrode segment. Thus, more generally, a method of dispensing a droplet described herein, in some embodiments, comprises withdrawing a portion of a reservoir fluid of a DMF device and forcing the portion to form an acute angle during de-wetting and movement of the portion over a curved electrode segment. In some cases, such a method further comprises pinching off or separating the portion from the remainder of the reservoir fluid, thereby forming the dispensed droplet. Moreover, in some such embodiments, dispensing a droplet comprises forming a tail extending between the droplet and the reservoir fluid, forming at least one fixed meniscus of the reservoir fluid adjacent to the tail, and forming a fixed meniscus of the droplet adjacent to the tail, wherein the fixed meniscus of the reservoir fluid is substantially orthogonal to the fixed meniscus of the droplet.

Additionally, methods of dispensing a droplet described herein, in some cases, can further comprise providing the dispensed droplet to an apparatus that is not a digital microfluidic device. For example, in some instances, the apparatus comprises a PCR apparatus.

### III. Methods of Splitting a Droplet in a Digital Microfluidic Device

In another aspect, methods of splitting a droplet in a DMF device are described herein. In some embodiments, a method of splitting a droplet described herein comprises moving a droplet over a droplet-splitting component described herein. Any droplet-splitting component described hereinabove in Section I may be used. For example, in some cases, a method of splitting a droplet comprises providing a droplet-splitting component comprising a first linear electrode segment, a second linear electrode segment, a third linear electrode segment, and a Y-junction electrode segment connecting the first linear electrode segment to the second and third linear electrode segments, wherein the first linear electrode segment, the second linear electrode segment, the third linear electrode segment, and the Y-junction electrode segment form a Y-shape and wherein the second and third linear electrode segments define an acute angle. Additionally, in some instances, the first linear electrode segment, the second linear electrode segment, the third linear electrode segment, and/or the Y-junction electrode is formed from a plurality of contiguous rectangular electrodes having an aspect ratio of about 4 to 10. The method further comprises moving the droplet from the first linear component to the Y-junction electrode segment to split the droplet into a first droplet portion and a second droplet portion. A method splitting a droplet according to one such embodiment is illustrated in FIGS. 7 and 8. More generally, however, a method of splitting a droplet described herein can comprise forcing a leading meniscus of a fluid droplet in a DMF device to split at an electrode junction defining an acute angle.

Various embodiments of the present invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A digital microfluidic device comprising a droplet-dispensing component, the droplet-dispensing component comprising:
a first linear electrode segment;
a second linear electrode segment; and
a curved electrode segment connecting the first linear electrode segment and the second linear electrode segment,
wherein the curved electrode segment subtends an angle of 85 to 95 degrees.

2. The device of claim 1, wherein the first linear electrode segment is formed from a plurality of contiguous electrodes.

3. The device of claim 2, wherein the contiguous electrodes of the first linear segment are rectangular.

4. The device of claim 3, wherein the contiguous electrodes of the first linear segment have the same size and shape.

5. The device of claim 3, wherein the contiguous electrodes of the first linear segment have a width of 0.1 to 2 mm and a length of 1 to 10 mm.

6. The device of claim 3, wherein the contiguous electrodes of the first linear segment have an aspect ratio of 4 to 8.

7. The device of claim 1, wherein the first linear electrode segment is formed from a plurality of contiguous electrodes and the second linear electrode segment is formed from a plurality of contiguous electrodes.

8. The device of claim 7, wherein the contiguous electrodes of the first linear segment are rectangular and the contiguous electrodes of the second linear segment are rectangular.

9. The device of claim 8, wherein the contiguous electrodes of the first linear segment have a width of 0.1 to 2 mm, a length of 1 to 10 mm, and an aspect ratio of 3 to 10, and the contiguous electrodes of the second linear segment have a width of 0.1 to 2 mm, a length of 1 to 10 mm, and an aspect ratio of 3 to 10.

10. The device of claim 1, wherein the curved electrode segment subtends an angle of 90 degrees.

11. The device of claim 1, wherein the curved electrode segment is formed from a plurality of sector-shaped electrodes.

12. The device of claim 11, wherein the sector-shaped electrodes have the same area and/or subtend the same angle.

13. The device of claim 1, wherein:
the first linear electrode segment is formed from a plurality of contiguous rectangular electrodes,
the second linear electrode segment is formed from a plurality of contiguous rectangular electrodes,
the curved electrode segment is formed from a plurality of sector-shaped electrodes, and
the sector-shaped electrodes of the curved electrodes have the same area as the rectangular electrodes of the first and second linear electrode segments.

14. The device of claim 1, wherein the droplet-dispensing component formed by the first linear electrode segment, the second linear electrode segment, and the curved electrode segment is L-shaped.

15. A method of dispensing a droplet from a reservoir fluid of a digital microfluidic device, the method comprising:
withdrawing a portion of the reservoir fluid; and
forcing the portion to form an acute angle during de-wetting and movement of the portion over a curved electrode segment.

16. The method of claim 15 further comprising separating the portion from the remainder of the reservoir fluid, thereby forming the dispensed droplet.

17. The method of claim 15, wherein the curved electrode segment connects a first linear electrode segment to a second linear electrode segment.

18. The method of claim 17, wherein the first linear electrode segment, the second linear electrode segment, and the curved electrode segment define an L-shape subtending an angle of 85 to 95 degrees.

19. The method of claim 15 further comprising:
forming a tail extending between the droplet and the reservoir fluid;
forming at least one fixed meniscus of the reservoir fluid adjacent to the tail; and
forming a fixed meniscus of the droplet adjacent to the tail,
wherein the fixed meniscus of the reservoir fluid is substantially orthogonal to the fixed meniscus of the droplet.

20. The method of claim 15 further comprising providing the dispensed droplet to an apparatus that is not a digital microfluidic device.
